(19) United States
(12) Patent Application Publication
(10) Pub. No.: US 2015/0294364 A1
(43) Pub. Date: Oct. 15, 2015

(54) SYSTEM AND METHOD FOR DISPLAYING ADVERTISEMENT IN AN APPLICATION

(71) Applicant: INMOBI PTE LTD, Singapore (SG)

(72) Inventor: Amit Deshpande, Belgaum (IN)

(73) Assignee: INMOBI PTE LTD, Singapore (SG)

(21) Appl. No.: 14/676,557

(22) Filed: Apr. 1, 2015

(30) Foreign Application Priority Data
Apr. 10, 2014 (IN) 1879/CHE/2014

(51) Int. Cl. G06Q 30/02; G06F 17/30

(52) U.S. Cl. CPC G06Q 30/0267; G06F 17/30312; G06F 17/3089

(57) ABSTRACT

The present invention provides a system and method for displaying advertisements in an application. The system and method include, receiving an advertisement request for displaying advertisement in the application installed on a mobile device, selecting an advertisement data from an advertisement server, transmitting the advertisement to the application, and displaying the advertisement in the application at the advertisement placement region during execution of the application

### FIELD OF INVENTION

The present invention relates to advertisements and in particular, the invention relates to displaying advertisements in an application.

### BACKGROUND

Over the past decade, the Internet has rapidly become an important source of information for individuals and businesses. The popularity of the Internet as an information source is due, in part, to the vast amount of available information that can be downloaded by almost anyone having access to a computer and a modem. Moreover, the internet is especially conducive to conduct electronic commerce, and has already proven to provide substantial benefits to both businesses and consumers.

Typically, advertising involves presenting advertisements based upon either of two formats. The first format, Static Ads, are inserted within an application during design and do not change once the application is shipped. Thus, for example, a storefront shown in a virtual environment of a video game clearly displays trademarks of an authentic storefront. Alternatively, a virtual cellular phone that a user is able to interact with in the context of an application features a design that mimics a design for a real cellular telephone. These non-changing, static, advertisements are used in combination with other application content to provide the virtual environment of the video game. Thus, throughout the usage of application, the advertising feature never changes. This is analogous to product placements within films.

A second type of advertisement within application that is now achieving popularity is dynamic ad placement. In dynamic ad placement, the advertising region within the application is predetermined and an advertisement is received dynamically from a broadband network to be inserted within the advertising region within the application. In a typical application, a billboard within the application is designated as an advertising region. Texture data and layering techniques are provided for mapping onto the billboard dynamically during the usage of application, and that texture is then mapped on the billboard as the billboard comes within the view of the user. Thus, the user sees the advertising content shown on the billboard within the virtual environment supported by the application. However, these layering and texturing techniques cannot control the advertisement placement region and the visibility of the advertisement during the execution of the application.

In light of the above discussion, there is a need for a method and system that overcomes all the above stated problems.

### BRIEF DESCRIPTION OF THE DRAWINGS

FIG. 1 illustrates the environment in which the advertisements are displayed during the execution of the application, in accordance with various embodiments of the present invention;

FIG. 2 illustrates the system components for displaying advertisements during the execution of the application, in accordance with various embodiments of the present invention;

FIG. 3 illustrates a flowchart for displaying advertisements during the execution of the application, in accordance with various embodiments of the present invention; and

FIG. 4 illustrates a block diagram of a computer server system, in accordance with various embodiments of the present invention.

### BRIEF DESCRIPTION OF THE INVENTION

The above-mentioned shortcomings, disadvantages and problems are addressed herein which will be understood by reading and understanding the following specification.

In embodiments, the present invention provides a method and system for displaying advertisements in an application. The method includes the steps of receiving an advertisement request from a mobile device, selecting an advertisement from an advertisement server, transmitting the advertisement data file to the application, and displaying the advertisement data file in an advertisement placement region upon the execution of the application.

The request for displaying advertisement in the application has one or more contextual criteria. The advertisement-request received has a user identifiable identifier, and content that has to be published. The contextual criteria include an indexing order of the plurality of ad placement regions in the application. The contextual criteria and the indexing order determine the visibility of the advertisement in the advertisement placement region. The indexing orders in which the advertisements are placed are according to a cascading style sheet method. The criteria for displaying advertisements in an application includes of an optical criteria of the application. The displaying of advertisements is triggered by an interrupt such as interfacing the application by a user.

The system for displaying advertisements in an application installed on a mobile device, the system includes one or more processors, one or more advertisement servers, a request receiver module, a selection module, and one or more databases. The request-receiving module is configured to receive ad requests from one or more applications installed on a mobile device. The selection module selects one or more advertisements based on contextual criteria. The databases store a plurality of data structures.

The plurality of data structures includes advertisements, advertisement. requests, plurality of contextual criteria, user information, publisher information and ad server information. The advertisement-serving platform is configured for communicating with the request receiver module and the selection module to transmit the relevant advertisement to the application according to the indexing order.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

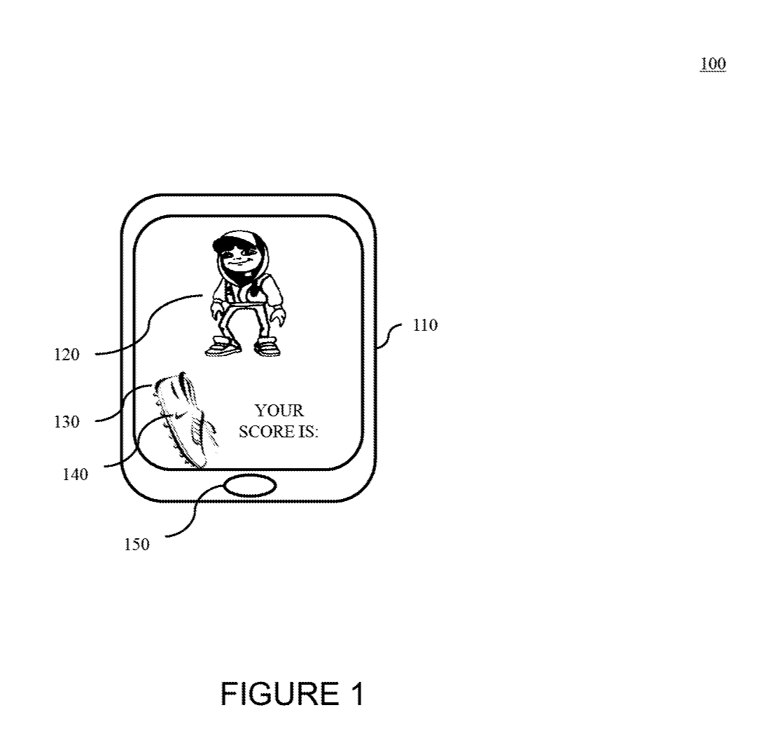

FIG. 1 illustrates an environment 100 in which the advertisements are displayed during the execution of the application, in accordance with various embodiments of the present invention. The environment 100 includes a mobile device 110 on which the advertisement is displayed via an installed application. In an embodiment, the mobile device 110 refers to a device capable of serving advertisements to a user (not shown in figure). Examples of mobile device 110 can be a laptop, smart-phone, tablets, personal digital assistants (PDA), gaming console, visual device, and the like.

The environment 100 includes a character 120. The character 120 is a character that is seen when the application is executed in the mobile device 110. In an embodiment, the application 110 refers to a gaming application. The term character 120 as used in gaming application refers to the user's in-game persona, such as a person in the game, a car, robot, and the like. In another embodiment, the character 120 can be a person, a car, a robot, and the like in a utility application. In another embodiment, the character 120 can be a person, a car, a robot, and the like in a sports application.

The environment 100 includes an object 130. The object 130 is a material that is shown for the purpose of advertisement during the execution of the application by the mobile device 110. The object 130 can be used as a part of the display in the application. For example, the object 130 can be used to show the number of coins the character 120 has gained during game play i.e., during the execution of the application using the mobile device 110. The object 130 can be considered as an advertisement placement region. In an embodiment, the object 130 and the advertisement placement region is one and the same. In another embodiment, the object 130 and the advertisement region is different from one another. In the environment 100, the object 130 is depicted as footwear that shows the number of coins the character 120 has gained during the execution of the game. In an embodiment, there is only one object 130, which can be used to display information along with the advertisement. In another embodiment, there can be one or more objects 130 that can be used to display information along with one or more advertisements. In an embodiment, the object 130 is placed exclusively by the developer of the application for the purpose of the advertisement. In another embodiment, the object 130 is placed for displaying the required information without the intension of the advertisement being placed on it.

The environment 100 includes an advertisement 140. In an embodiment, there is only one advertisement 140 for the object 130. In another embodiment, there can be one or more advertisements 140 in the object 130. In another embodiment, there can be one or more advertisements 140 in one or more objects 130. The advertisements can be placed in a customized way in the object 130. In an embodiment, an advertisement-serving network customizes the advertisement 130. In another embodiment, an application developer customizes the advertisement 130. In yet another embodiment, a publisher of the advertisement customizes the advertisement 130. For example, in the environment 100, the advertisement 140 is a Nike® logo in the object 130. The display of Nike® logo can be customized according to the advertiser's need. The advertisement 140 can be replaced by any other logo. For example, the advertisement 140 can be a logo, image, motion picture, video and the like. In an embodiment, the customization refers to graded opacity (i.e., visibility) of the advertisement 140 in the object 130. The graded opacity of the advertisement can be varied from being transparent to opaque. For example, in the environment 100, the Nike® logo can be made transparent, translucent or opaque. Transparent refers to a state where the background of the object 130 can be seen i.e. the footwear background can be seen through the Nike® logo. Translucent is defined as having characteristics of a translucent medium. For example, if the advertisement 140 is customized to be translucent, then the background of the object 130 is partially visible against the Nike® logo. Opaque refers to a state where the background of the object 130 cannot be seen at all against the advertisement 140. For example, if the advertisement 140 is customized to be opaque, then the object 130 is not seen against the Nike® logo. The advertisement 140 is customized according to the index order.

The environment 100 includes an interface 150 through which the application on the mobile device 110 can be opened, executed and closed. In an embodiment, the interface 150 is a hardware interface. For example, the hardware interface includes but not limited to a button, a keypad, a joystick, and touch user interface (TUI). In another embodiment, the interface 150 is a software interface. For example, the software interface can include but not limited to touch-screen, graphical user interface (GUI), and the like.

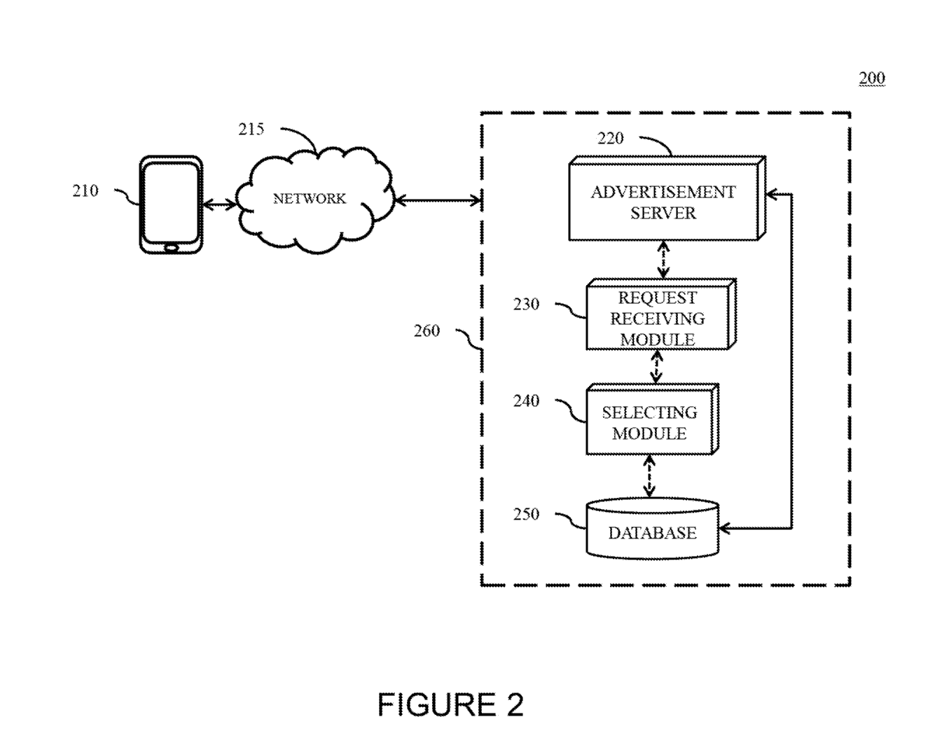

FIG. 2 illustrates the system 200 for displaying advertisements during the execution of the application, in accordance with various embodiments of the present invention. The system 200 includes a mobile device 210 through which the advertisement requests are sent. In an embodiment. the mobile device 210 and the mobile device 110 are one and the same. In another embodiment, the mobile device 210 and the mobile device 110 are different devices. The mobile device 210 sends the advertisement requests through a network.

FIG. 2 includes a network 215. The network 215 refers to one or more of a variety of networks or other types of communication connections. For example, the network 215 may be an internet, an intranet network, a local area network, a wireless connection, a hardwired connection and the like. The mobile device 210 communicates with an advertisement serving platform, a publisher web server (not shown in figure) and with other devices using the network 215. The publisher web server refers to a server belonging to a company that publishes content via a site, application, blog, and the like. Examples of publisher web server can be the servers owned by Google®. Yahoo!® and the like. Publisher web server provides advertisement slots and region to the advertisers. Different advertisement slots and regions can represent different sections of a publisher's site or different placements for advertisements within single web content.

System 200 includes an advertisement-serving platform 260. The advertisement-serving platform 130 refers to a computing platform that enables advertisers to manage, deliver and display advertising content that publisher web server (not shown in figure) deliver to mobile device 210. Examples of advertisement-serving platform 210 can be Google Adsense®. Yahoo! Panama ^{TM}, InMobi® and the like.

In the system 200, the advertisement-serving platform 260 includes an advertisement server 220. a request-receiving module 230, a selection module 240, and a database 250. In an embodiment, the advertisement-serving platform 260 is a computing platform that serves advertisements to the users in a designated manner. The common functionalities of the advertisement-serving platform 260 are to upload advertisements from plurality advertisers, trafficking advertisements according to differing business rules, targeting advertisements to different users, tuning and optimizing based on results obtained, reporting impressions, clicks, post-clicks to generate revenue module and the like. The advanced functionalities of the advertisement-serving platform 260 include customizing advertisements according to the changing trends, frequency capping, sequencing advertisements and the like.

In the system 200, the advertisement server 220 refers to a computer system that stores, maintains, and serves advertisements to one or more applications. The advertisement-server 220 programs, tracks and report several statistics about application visitors that are used by advertisement providers to generate revenue. In an embodiment, the advertisement server 220 is a local server. A local server serves advertisements only to a single web publisher. In another embodiment, the advertisement server 220 is a remote server. A remote server serves advertisements to plurality of publishers. In yet another embodiment, the advertisement server 220 is a third party server. Further, the advertisement server 220 interacts with the publisher web server via the network 215 for publishing the advertisements in the advertising slots of the web content.

in the system 200, the advertisement-serving platform 260 includes the request-receiving module 230. The request-receiving module receives one or more advertisement requests from the mobile device 210 through the advertisement server 220. The advertisement request includes information about the devices connected to the mobile device 210, as well as the information about the mobile device 210. The request-receiving module 230 receives an advertisement request corresponding to execution of a particular application or a web browser from the mobile device 210. Further, the request-receiving module 230 discards the advertisement requests that do not match a standard header format. In an embodiment, if the date of creation of the advertisement is not given in a proper format (For example, if the advertisement server receives an advertisement request on Jan. 1, 2013 and the advertisement header has the information that the advertisement was created on Feb. 1, 2014), the request-receiving module 230 discards that particular advertisement request. In another embodiment, the request-receiving module 230 discards the advertisement request received from prohibited and blacklisted mobile devices.

The system 200 includes, the advertisement-serving platform 260 includes a selection module 240. The selection module 240 selects the advertisement according to the contextual criteria, of the advertisement-request. The contextual criteria of the advertisements include but not limited to indexing order, device criteria, preference criteria and the like. In an embodiment, the indexing criterion is the major criteria that determine the selection of the advertisement. In another embodiment, the criteria can be explicitly mentioned by the advertisement-serving platform 260. The optical criteria of the advertisements include but not limited to reflectivity of the advertisement, smoothness of the advertisement, and temperature property of the advertisement (For example, cool, warm, and normal). In yet another embodiment, the selection module 240 selects the advertisement automatically. The selection module 240 selects one or more advertisements from the database. The automatic selection of the advertisement is done by predetermined set of rules. The predetermined set of rules comprises an algorithm and the output of the algorithm is dependent upon indexing order of the advertisement, contextual criteria of the application, optical criteria of the application.

Once the advertisement is selected from the database, the advertisement data file is transmitted to the advertisement placement region 130 according to the indexing order provided by the advertisement-serving platform 260. The selected advertisement can be provided with the required graded opacity according to the advertisement-serving platform's 260 needs.

In the system 200, the advertisement-serving platform 260 includes a database 250. The database 250 is used for storing plurality types of information. The database 250 includes information about users, plurality of publishers, one or more advertisement templates, indexing order of one or more advertisements, advertisement access control table, charging list information, fees calculating information, geographic locations, advertising zones, point of interest data, optical criteria. The database 250 may also include other kinds of data. The other kinds of data may represent other types of advertising criteria.

The database 250 interacts with the advertising platform 260 for storing advertisements and for selecting advertisements according to the selection module 240. The advertisement requests received by the request-receiving module 230 are stored in the database 250. The database 250 also stores metadata of the advertisements data files sent to different mobile devices.

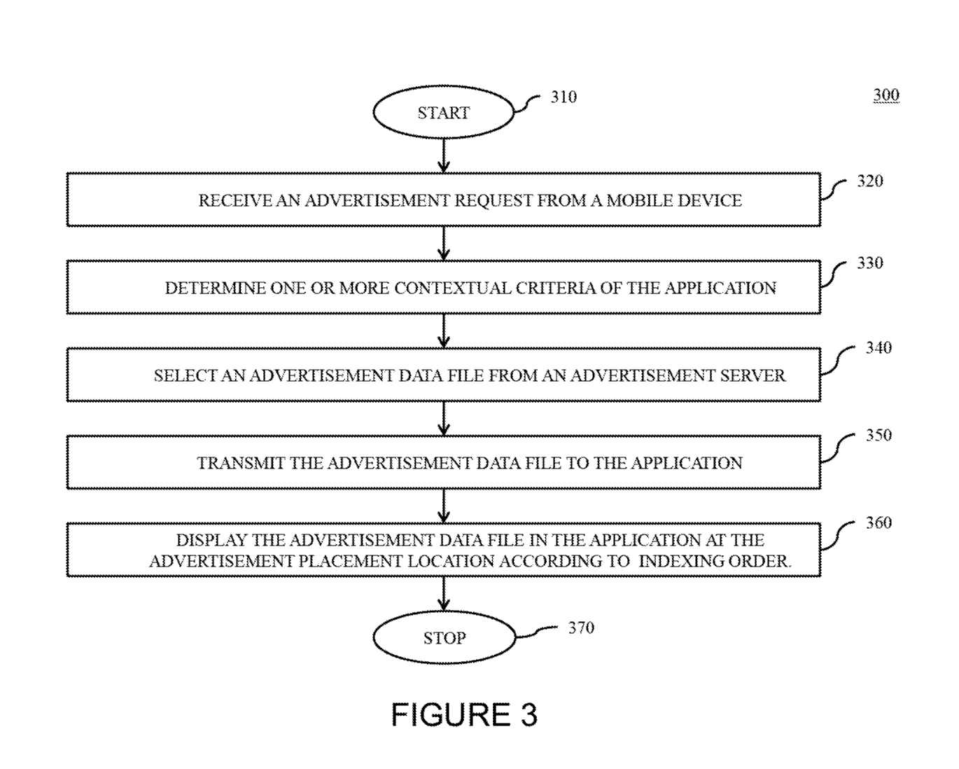

FIG. 3 illustrates a flowchart 300 for displaying advertisements during the execution of the application, in accordance with various embodiments of the present invention. The flowchart initiates at step 310.

At step 320, the advertisement request is received from the mobile device 210. The advertisement request is received by the advertisement server 220 and is sent to the request-receiving module 230. At step 320 invalid advertisement requests are discarded and only advertisement request requests for which advertisement data file can be transmitted is considered. An invalid advertisement request is an advertisement request that is not in a proper format. At step 320, when the advertisement request is received from the mobile device 210 by the advertisement-serving platformn 260, the metadata of the advertisement request is stored in the database 250. The metadata of the advertisement request may include but not limited to be information of the mobile device 210 such as mobile type (For example, iPhone, android phone or windows phone), geographical location of the device, that particular request was sent due to execution of which particular application and the like. Once the advertisement request is received, it is sent for further processing for the determination of contextual criteria.

At step 320, the contextual criteria of the advertisement request is determined. The contextual criteria, include indexing criteria. In an embodiment, the indexing criterion is set by the advertisement-serving platform 260. In another embodiment, the indexing criterion is set by the publisher of the advertisement. The indexing criterion .determines the opacity grade or the transparency range of the advertisement on the item 130 at the advertisement placement region 140. The indexing criterion is determined by the values of the advertisement against the advertisement placement region 140. The advertisement on the advertisement placement region 140 can be made transparent, translucent and opaque. For example, if the indexing order for a particular advertisement request is mentioned as 1, in a scale of 1-10, against the advertisement placement region 140, then that particular advertisement is displayed as a transparent advertisement in the advertisement placement region 140. For example, if the indexing order for a particular advertisement request is mentioned as 5, in a scale of 1-10 against the advertisement placement region 140, then that particular advertisement is displayed as a translucent advertisement in the advertisement placement region 140. For example, if the indexing order for a particular advertisement request is mentioned as 10, in a scale of 1-10 against the advertisement placement region 140, then that particular advertisement is displayed as an opaque advertisement in the advertisement placement region 140. In another embodiment, the opacity grade is determined in terms of relative index order. For example, if the advertisement has an indexing order of 1 and the advertisement placement region 140 has an indexing order of 10, then the advertisement is made transparent and is placed in front of the object 130 at the advertisement placement region 140. In another example, if the advertisement has an indexing order of 5 and the advertisement placement region 140 has an indexing order of 1, then the advertisement is made translucent and is placed behind the object 130. Thus on a scale of 1 to 10 the transparency of the advertisement varies as per the requirement within this range.

The advertisement request sent by the mobile device 210 contains the optical criteria of the application in which the advertisement has to be displayed. The optical criteria can include but not limited to color of the application, background of the application, advertising item, temperature property of the advertisement and the like. Once the contextual criterion is determined by the advertisement-serving platform 260, it is sent to the advertisement selection module 240.

At step 340, an advertisement satisfying the indexing criterion, the contextual criteria, and the optical criteria is selected from the database 250 by the selection module 240. The indexing order of the advertisement to be placed is according to a cascading style sheet (CSS). The cascading style sheet is used primarily to enable the separation of advertisement content from advertisement presentation, including elements such as layout, colors, and font. In an embodiment, the advertisement has one or more portions. The one or more portions of the advertisement is separated into one or more regions. The separation of the advertisement into one or more portions can improve content accessibility, and flexibility. The separation of the advertisement into one or more portions can also control the specification of presentation characteristics, enable multiple pages to share formatting, and reduce complexity and repetition in the structural content. The cascading style sheet (CSS) used place advertisement according to indexing order allows the markup page to be presented in different styles for different methods, such as on-screen, in print, by voice, and the like. In an embodiment, a. cascading styling property known as z-index method is used for selecting advertisement from the database 250. The z-index method sets the indexing order of specific elements. An element with greater index order will always be in front of the element having a lower index order. For example, if the advertisement has the greater index order, then the advertisement is seen in front of the object 130. The advertisement-serving platform 260 customizes the z-index order to set the advertisement as transparent, translucent or opaque. In an embodiment, the z-index order also makes the advertisement dynamic. For example, the advertisement can be changed from Nike® logo to Reebok® logo according to the requirement of the advertisement-serving platform 260. Once the advertisement is selected by the selection module 240, it is transmitted to the mobile device 210 for displaying the advertisement.

At step 350, the advertisement is transmitted to the mobile device 210. The advertisement is transmitted to the mobile device 210 through the network. 215. The advertisement comprises of one or more images, audio, video, multimedia file and the like according to the selected contextual criteria. In an embodiment, the advertisement is transmitted. to the mobile device 210 is in encrypted format. in another embodiment, the advertisement is transmitted to the mobile device 210 without encryption. Once the advertisement is transmitted to the mobile device 210, processing is done for displaying advertisement on the mobile device 210 upon the execution of the application.

At step 360, the advertisement is displayed on the mobile device 210. The advertisement is displayed on the mobile device 210 at the advertisement placement region 140 according to the selected criteria. The selected criteria include indexing order, the contextual criteria, and the optical criteria. The advertisement displayed can be in the transparent, translucent or opaque according to the customization done by the advertisement-serving platform 260 for each of particular application. The flowchart terminates at step 370. The advantage of the present invention is that the advertisements can be changed dynamically and also can be customized according to the requirement of advertisement-serving platform 260 without changing the source code.

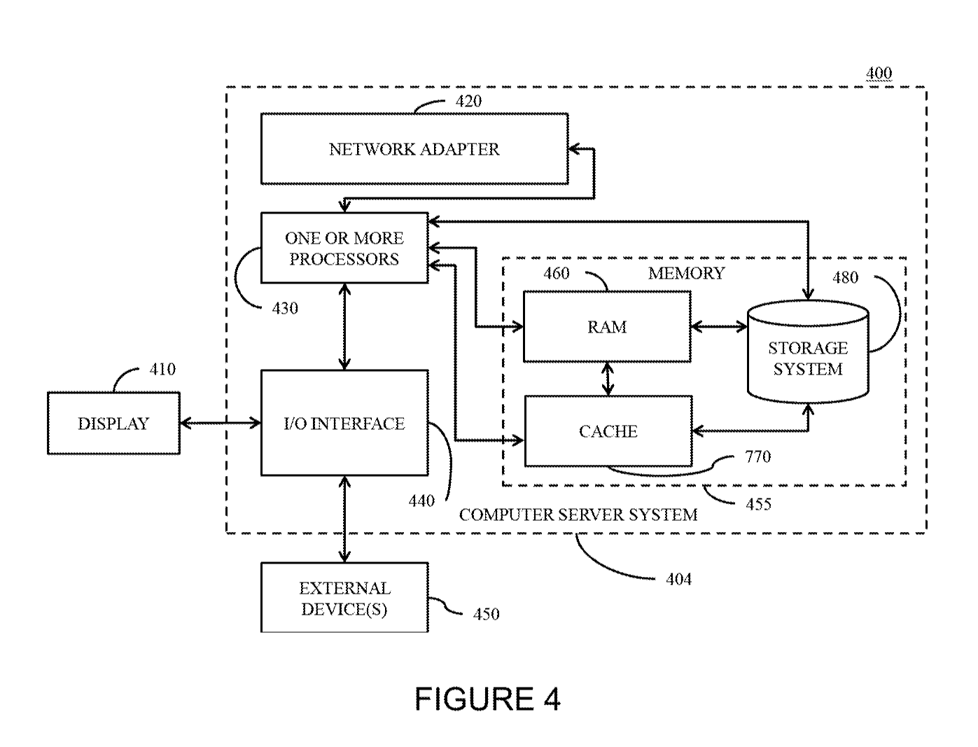

FIG. 4 illustrates a block diagram of a. computer server system,.

in accordance with various embodiments of the present invention. In FIG. 4, the computer server 405 in the computer node 400 is shown in the form of a general-purpose computing device. The components of computer server 405 include, but are not limited to, processing unit 430, a system memory 455, a network adapter 420, an input-output (I/O) interface 440 and one or more buses that couples various system. components to processing unit 430.

The one or more buses represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer server 405 typically includes a variety of computer system readable media. Such media may be any available media that is accessible by computer server 405, and includes both volatile and non-volatile media., removable and non-removable media. In an embodiment, the system memory 455 includes computer system readable media in the form of volatile memory, such as random access memory (RAM) 460 and cache memory 470. Computer server 405 may further include other removable/non-removable, non-volatile computer system storage media. In an embodiment, the system memory 455 includes a storage system 480.

Computer server 405 can communicate with one or more external devices 450 and a display 410, via input-output (I/O) interfaces 440. In addition, computer server 405 can communicate with one or more networks such as a local area network (LAN), a general wide area network (WAN), and/or a public network (for example, the Internet) via the network adapter 420.

It can be understood by one skilled in the art that although not shown, other hardware and/or software components can be used in

conjunction with the computer server 205. Examples, include, but are riot limited to microcode, device drivers, redundant processing units, external disk drive arrays, RAID systems, tape drives, and data archival storage systems, and the like.

What is claimed is:

1. A method for displaying advertisements in an application, the method comprising the steps of
a. receiving an advertisement request for displaying advertisement in the application installed on a mobile device, wherein the request for displaying advertisement in the application has a contextual criteria, wherein the contextual criteria comprises an indexing order of a plurality of ad placement regions in the application;
b. selecting an advertisement from an advertisement server, the advertisement comprising one or more advertisement , a specified contextual criteria and a specified optical criteria;
c. transmitting the advertisement to the application; and
d. displaying the advertisement in the application at one or more ad placement region during execution of the application, wherein the advertisement has one or more indexing order in proportion to that of the one or more ad placement region in the application.

2. The method as claimed in claim 1, wherein the advertisement has one or more portions.

3. The method as claimed in claim 1, wherein indexing order specifies a graded opacity for one or more portions of the advertisement in the application.

4. The method as claimed in claim 1, wherein the contextual criteria of the application further specify one or more rules to facilitate visibility of the advertisement image at the advertisement placement region.

5. The method as claimed in claim 1, wherein the one or more ad placement regions and the one or more advertisement content have a cascading style sheet component.

6. The method as claimed in claim 1, wherein the optical criteria of the application further specify one or more rules to facilitate visibility of the advertisement image at the advertisement placement region.

7. The method as claimed in claim 1, wherein the displaying of advertisements is triggered by an interrupt of the application by a user.

8. The method as claimed in claim 1, wherein the advertisement request includes an identifier for a user-requested Publisher web content item.

9. A system for displaying advertisements in an application installed on a mobile device, comprising:
a. one or more processors;
b. an advertisement serving platform;
c. a request receiver module configured to receive ad requests from one or more applications installed on a mobile device;
d. a selection module for selecting advertisements based on contextual criteria; and
e. one or more databases for storing a plurality of data structures;

10. The system as claimed in claim 8, wherein the plurality of data. structures comprises of advertisements, advertisement requests, plurality of contextual criteria, user information, publisher information and, ad server information; and

[symbol]

11. The system as claimed in claim 8, Wherein the advertisement serving platform is configured to communicate with the request receiver module and the selection module to transmit the advertisement to the application according to an indexing order.
